(19) United States
(12) Patent Application Publication
(10) Pub. No.: US 2024/0211367 A1
(43) Pub. Date: Jun. 27, 2024

(54) PIPELINE EVALUATION DEVICE, PIPELINE EVALUATION METHOD, AND PROGRAM

(71) Applicant: NEC Corporation, Tokyo (JP)

(72) Inventors: Keita SAKUMA, Tokyo (JP); Ryuta Matsuno, Tokyo (JP)

(73) Assignee: NEC Corporation, Tokyo (JP)

(21) Appl. No.: 18/539,410

(22) Filed: Dec. 14, 2023

(30) Foreign Application Priority Data
Dec. 21, 2022 (JP) 2022-204549

(51) Int. Cl. G06F 11/34; G06F 11/30

(52) U.S. Cl. CPC G06F 11/3409; G06F 11/3051

(57) ABSTRACT

In a pipeline evaluation device, a data acquisition means acquires time series data. A pipeline execution means executes a pipeline using the data being acquired, and generates an execution result. A metric calculation means calculates an evaluation metric using the execution result acquired by executing the pipeline by using the execution result, and outputs an evaluation result.

### TECHNICAL FIELD

The present disclosure relates to an evaluation of pipelines which operate machine learning models.

### BACKGROUND ART

A pipeline is used to automate an operation of a machine learning model. The pipeline refers to a program or a system which automates a manual machine learning operation process. A plurality of components forming the pipeline operate together to achieve the automatic operation of the machine learning model. Low pipeline performance results in disadvantages during the operation of the machine learning model. Therefore, it is necessary to evaluate the performance and risk of the pipeline before the operation and to optimize a configuration of the pipeline. Patent Document 1 describes a parameter adjustment of an analysis pipeline model.
Patent Document 1: International Publication WO2018/002967

### SUMMARY

While the patent document describes an adjustment of parameters of a pipeline, it is necessary to evaluate not only the parameters but also a performance of the pipeline as a whole in order to assess the performance and a risk of the pipeline as a whole.

It is one object of the present disclosure to provide a pipeline evaluation device capable of appropriately evaluating the performance of the entire pipeline.

According to an example aspect of the present disclosure, there is provided a pipeline evaluation device including:
at least one memory configured to store instructions; and
at least one processor configured to execute the instructions for a pipeline evaluation process to:
acquire time series data;
execute a pipeline with the acquired time series data, and generate an execution result; and
calculate an evaluation metric using the execution result which evaluates the pipeline based on a profit acquired by executing the pipeline, and output an evaluation result.

According to another example aspect of the present disclosure, there is provided a pipeline evaluation method executed by a computer for a pipeline evaluation process, the method including:
acquiring time series data;
executing a pipeline with the acquired time series data, and generating an execution result; and
calculating an evaluation metric using the execution result which evaluates the pipeline based on a profit acquired by executing the pipeline, and outputting an evaluation result.

According to still another example aspect of the present disclosure, there is provided a recording medium storing a program, the program causing a computer to perform a process including:
acquiring time series data;
executing a pipeline with the acquired time series data, and generating an execution result; and
calculating an evaluation metric using the execution result which evaluates the pipeline based on a profit acquired by executing the pipeline, and outputting an evaluation result.

According to the present disclosure, it becomes possible to appropriately evaluate performance of the entire pipeline.

### BRIEF DESCRIPTION OF THE DRAWINGS

FIG. 1 conceptually illustrates a method in example embodiments;

FIG. 2 illustrates a conceptual configuration of a pipeline evaluation device according to the example embodiments;

FIG. 3 is a block diagram illustrating a hardware configuration of the pipeline evaluation device;

FIG. 4 is a block diagram illustrating a functional configuration of a pipeline evaluation device according to a first example embodiment;

FIG. 5 is a block diagram illustrating a functional configuration of a data dependency evaluation section;

FIG. 6 is a block diagram illustrating a functional configuration of a random number dependency evaluation unit;

FIG. 7 is a block diagram illustrating a functional configuration of a pipeline evaluation unit;

FIG. 8 is a block diagram illustrating a functional configuration of a simulation unit;

FIG. 9 is a block diagram illustrating a functional configuration of a metric calculation unit;

FIG. 10 is a block diagram illustrating a functional configuration of a data generation unit;

FIG. 11 is a block diagram illustrating a functional configuration of an optimization unit;

FIG. 12 schematically illustrates an operation of a pipeline evaluation unit;

FIG. 13 schematically illustrates an operation of the simulation unit;

FIG. 14 is a flowchart for explaining a simulation process;

FIG. 15 schematically illustrates an operation of a metric calculation unit;

FIG. 16 schematically illustrates an operation of a random number dependency evaluation unit;

FIG. 17 illustrates an example of a method for performing a pipeline evaluation by changing a random number during retraining;

FIG. 18 schematically illustrates an operation of a data generation unit:

FIG. 19 schematically illustrates an operation of the data dependency evaluation unit;

FIG. 20 schematically illustrates an operation of an optimization unit;

FIG. 21 is a flowchart of a pipeline optimization process;

FIG. 22 illustrates an example of data in a specific example of an optimization;

FIG. 23 is a block diagram illustrating a configuration of a pipeline evaluation device according to a second modification;

FIG. 24 is a block diagram illustrating a functional configuration of a pipeline evaluation device according to a second embodiment; and

FIG. 25 is a flowchart of a process by a pipeline evaluation device of the second embodiment.

### EXAMPLE EMBODIMENTS

In the following, preferred example embodiments of the present disclosure will be described with reference to the accompanying drawings.

### <Explanation of Principle>

### (Pipeline)

In an automatic operation of a machine learning model, a pipeline is used. Specific components forming the pipeline include, for instance, the following:

### (1) Pre-Process Components

Data are converted into data in a form which can be input into the machine learning model.

### (2) Predictive Component

A prediction is carried out for the input data, and a prediction result is output. Also, accumulate logs of forecast results.

(3) Data collection Components

Daily inputs (explanatory variables) and actual measured values of target variables are accumulated.

### (4) Accuracy Monitoring Component

A daily average accuracy is monitored every day. Retraining is triggered when the accuracy falls below a predetermined threshold.

### (5) Retraining Components

Data of the most recent predetermined period (that is, one month) are extracted as training data, and data of a predetermined period (that is, three days) in the most recent predetermined period are extracted as test data. The machine learning model is retrained using the training data, and an accuracy of the model after the retraining is verified using test data.

One of the problems in utilizing the pipeline is a lack of a mechanism for properly evaluating and improving the pipeline as a whole. A condition for a preferable pipeline may be that each of the components forming the pipeline is properly coordinated, that a machine learning model can be stably operated by adapting to a change in an environment, or the like. To realize the preferable pipeline, it is necessary to evaluate the performance of the entire pipeline. Specifically, it is necessary to calculate an evaluation metric for the entire pipeline, and evaluate the expected value and uncertainty (risk) of that evaluation metric, and also to optimize the pipeline based on an evaluation result.

In addition, as a problem by including a machine learning model inside the pipeline, a behavior of the pipeline changes in time series. For example, since the machine learning model inside the pipeline is changed by the retraining, the prediction result is different in a case where the input time is different, even if the input data are the same.

Specifically, the behavior of the pipeline varies dynamically with respect to the data which have been input in time series. This is called “data dependency”. To counter the data dependency, time series simulation is necessary, and a risk evaluation for the diversified data is important.

Also, depending on the components forming the pipeline, the behavior of the pipeline depends on a random number seed. This is called a “random number dependency”. To counter the random number dependency, the risk evaluation for a variety of random numbers is important.

From this viewpoint, in the example embodiment, in addition to introducing an evaluation metric to evaluate the entire pipeline, the data dependency and the random number dependency are evaluated, and the pipeline is optimized based on these evaluation results.

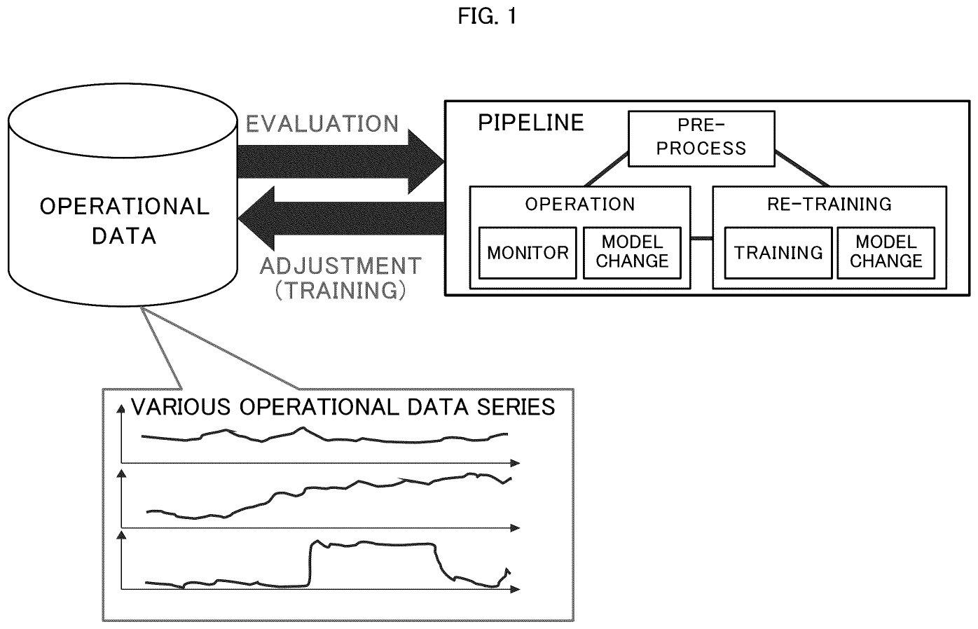

FIG. 1 conceptually illustrates a method of the example embodiment. In the method of the example embodiment, operational data including various operational data sequences are prepared, and are input to the pipeline. The pipeline includes various components such as a pre-process, a retraining, or the like as described above. The method of the present example embodiment evaluates the entire pipeline by inputting the various operational data sequences and simulating the operation of the pipeline. Specifically, the method of the present example embodiment operates the pipeline by inputting the various operational data sequences, evaluates the performance of the pipeline using the evaluation metric of the entire pipeline, and also evaluates the data dependency and the random number dependency. Subsequently, the method of this example embodiment optimizes the pipeline by performing adjustment (training) of the machine learning model based on the evaluation result.

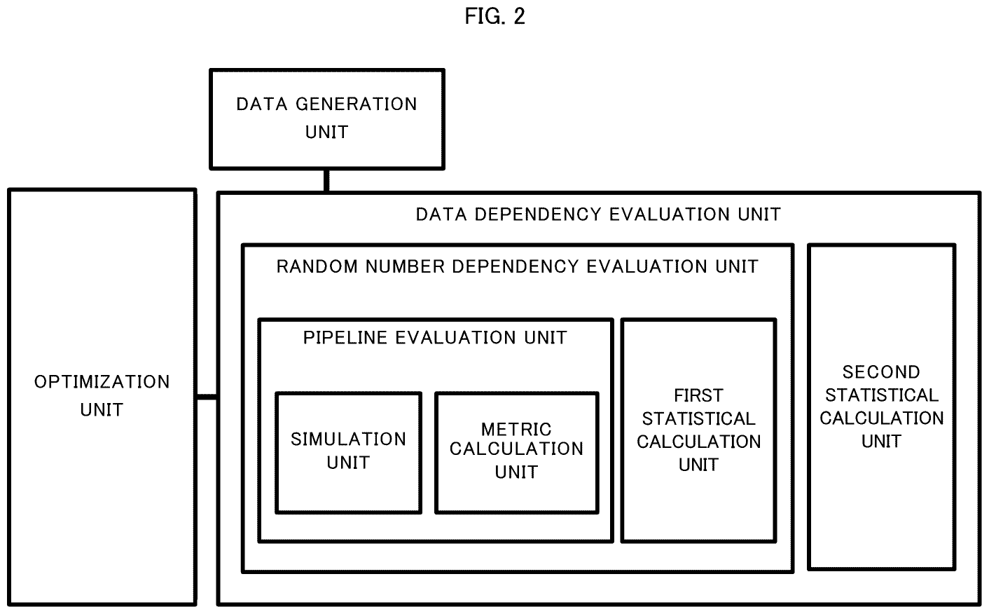

FIG. 2 illustrates a conceptual configuration of a pipeline evaluation device according to the example embodiment. The pipeline evaluation device roughly includes a data generation unit, a data dependency evaluation unit, and an optimization unit. The data dependency evaluation unit includes a random number dependency evaluation unit, and the random number dependency evaluation unit includes a pipeline evaluation unit. That is, the pipeline evaluation device is formed by a nested structure in which the random number dependency evaluation unit is included in the data dependency evaluation unit and the pipeline evaluation unit is included in the random number dependency evaluation unit. With this structure, the pipeline evaluation unit is repeatedly used in the evaluation performed by the random number dependency evaluation unit, the random number dependency evaluation unit is repeatedly used in the evaluation performed by the data dependency evaluation unit.

The pipeline evaluation unit performs a simulation using the operational data sequences, and calculates an evaluation metric which evaluates the entire pipeline based on the obtained result. The random number dependency evaluation unit repeatedly executes an evaluation by the pipeline evaluation unit while changing a random number seed, and evaluates the random number dependency of the pipeline. The data dependency evaluation unit repeatedly executes an evaluation by the random number dependency evaluation unit using a plurality of sets of operational data generated by the data generation unit, to evaluate the data dependency of the pipeline. Then, the optimization unit repeatedly executes the evaluation by the data dependency evaluation unit, and optimizes the pipeline based on the obtained evaluation result. Note that the optimization unit can optimize the pipeline using each evaluation result by at least one of the pipeline evaluation unit, the random number dependency evaluation unit, or the data dependency evaluation unit.

### First Example Embodiment

### [Hardware Configuration]

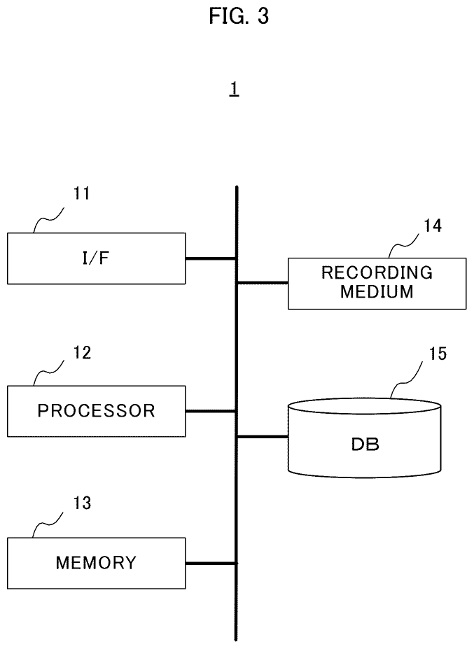

FIG. 3 is a block diagram illustrating a hardware configuration of a pipeline evaluation device 1. As illustrated, the pipeline evaluation device 1 includes an interface (I/F) 11, a processor 12, a memory 13, a recording medium 14, and a database (DB) 15.

The I/F 11 inputs and outputs data to and from an external device. Specifically, the operational data used in an evaluation of the pipeline are input to the pipeline evaluation device 1 through the I/F 11. Moreover, the evaluation result generated by the pipeline evaluation device 1 is output to the external device through the I/F 11 as needed.

The processor 12 is a computer such as a CPU (Central Processing Unit) and controls the entire pipeline evaluation device 1 by executing programs prepared in advance. The processor 12 may be a GPU (Graphics Processing Unit) or a FPGA (Field-Programmable Gate Array). The processor 12 performs various process performed by the pipeline evaluation device 1.

The memory 13 is formed by a ROM (Read Only Memory) and a RAM (Random Access Memory). The memory 13 is also used as a working memory during various process operations by the processor 12.

The recording medium 14 is a non-volatile and non-transitory recording medium such as a disk-shaped recording medium, a semiconductor memory, and is detachably formed with respect to the pipeline evaluation device 1. The recording medium 14 records various programs executed by the processor 12. Upon executing various processes by the pipeline evaluation device 1, the programs recorded on the recording medium 14 are loaded into the memory 13 and executed by the processor 12.

The DB 15 functions as various types of the DB to be described later, and stores various types of data and evaluation results generated during operation of the pipeline evaluation device 1. The DB 15 stores the data of the pipeline to be evaluated, reference data which are the basis of the operational data, and various types of operational data generated using the reference data.

### [Functional Configuration]

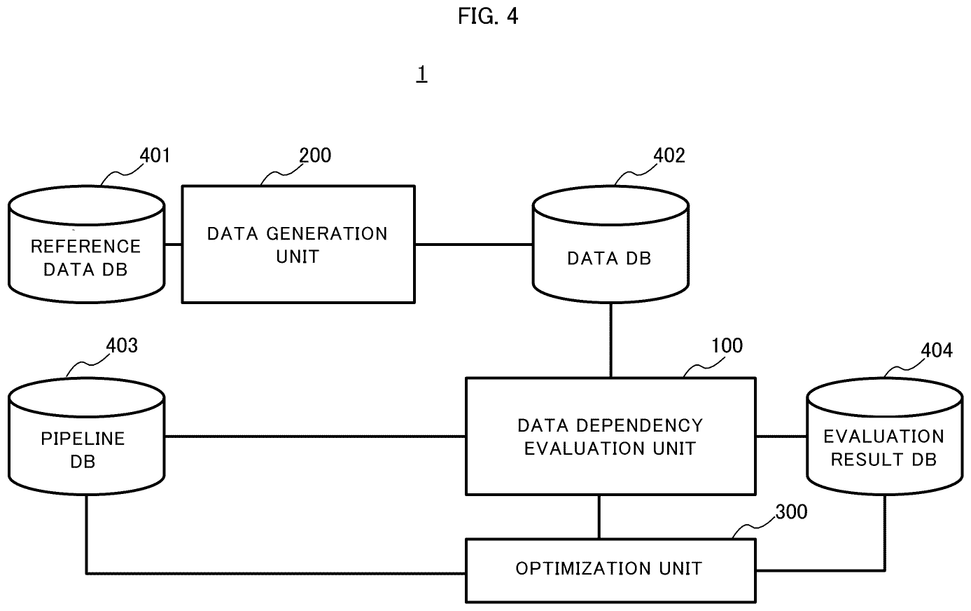

FIG. 4 is a block diagram illustrating a functional configuration of the pipeline evaluation device 1 of the first example embodiment. The pipeline evaluation device 1 includes a data dependency evaluation unit 100, a data generation unit 200, an optimization unit 300, a reference data DB 401, a data DB 402, a pipeline DB 403, and an evaluation result DB 404.

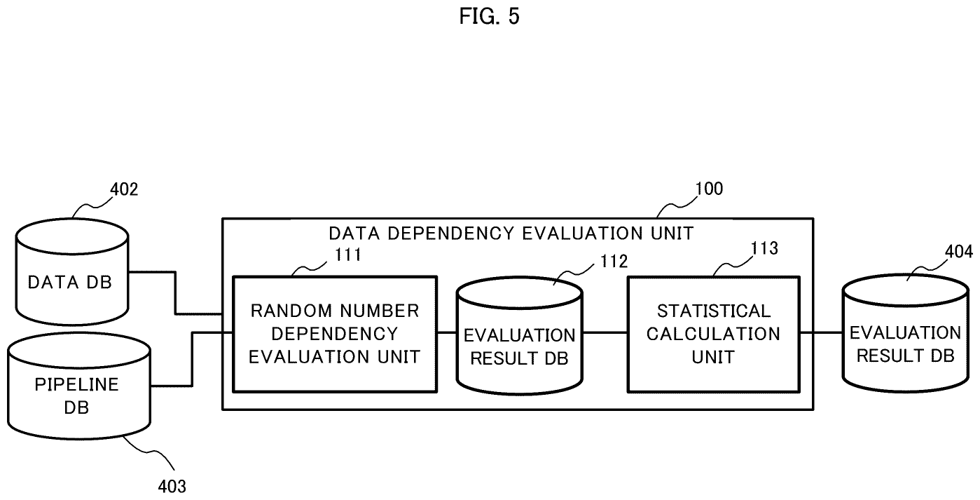

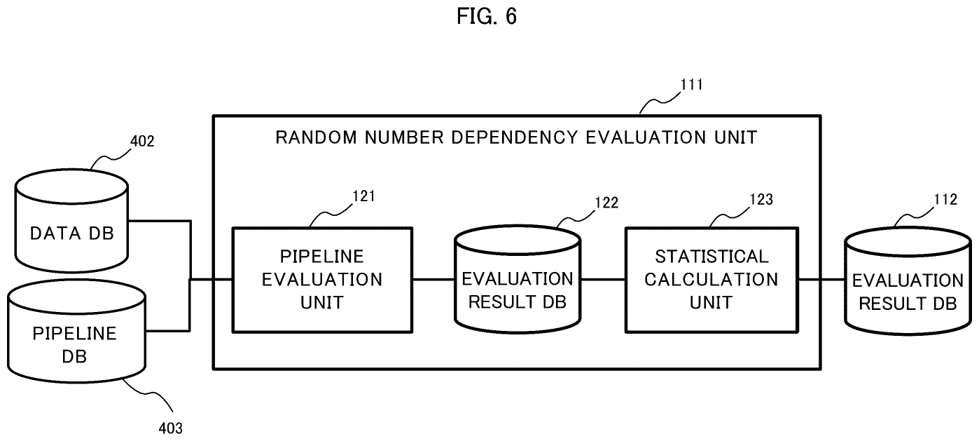

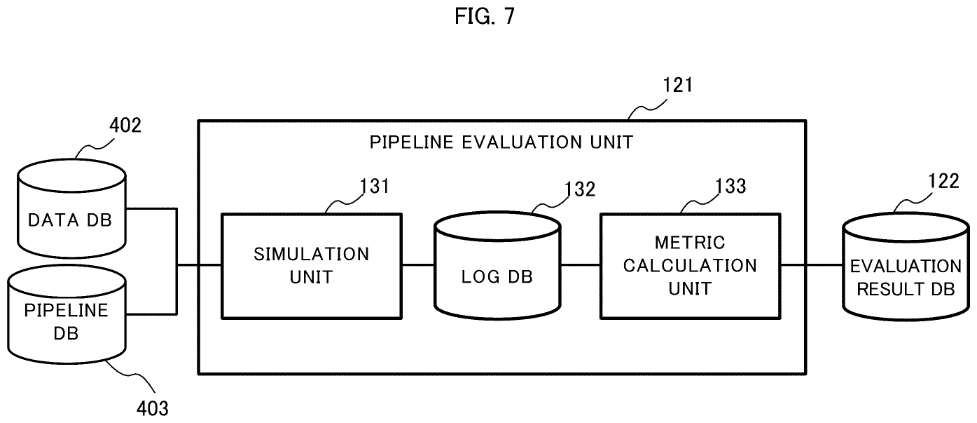

FIG. 5 is a block diagram illustrating a functional configuration of the data dependency evaluation unit 100 depicted in FIG. 4. The data dependency evaluation unit 100 includes a random number dependency evaluation unit 111, an evaluation result DB 112, and a statistical calculation unit 113. FIG. 6 is a block diagram illustrating a functional configuration of the random number dependency evaluation unit 111 depicted in FIG. 5. The random number dependency evaluation unit 111 includes a pipeline evaluation unit 121, an evaluation result DB 122, and a statistical calculation unit 123. FIG. 7 is a block diagram illustrating the functional configuration of the pipeline evaluation unit 121 depicted in FIG. 6. The pipeline evaluation unit 121 includes a simulation unit 131, a log DB 132, and a metric calculation unit 133.

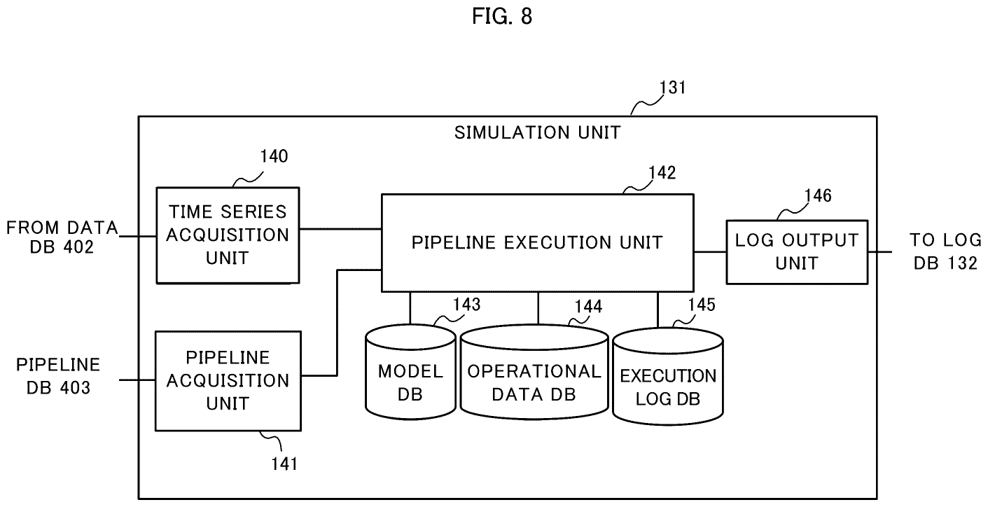

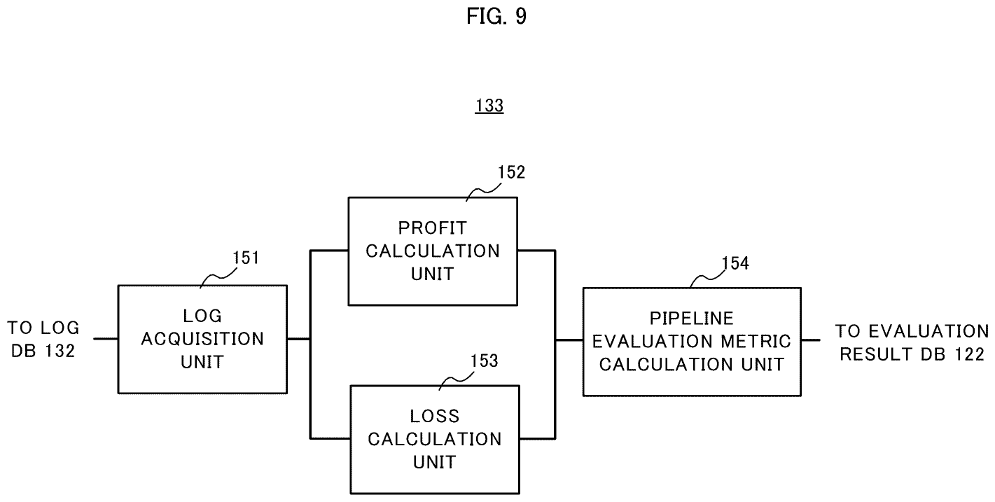

FIG. 8 is a block diagram illustrating a functional configuration of the simulation unit 131 depicted in FIG. 7. The simulation unit 131 includes a time series acquisition unit 140, a pipeline acquisition unit 141, a pipeline execution unit 142, a model DB 143, an operational data DB 144, an execution log DB 145, and a log output unit 146. FIG. 9 is a block diagram illustrating a functional configuration of the metric calculation unit 133 illustrated in FIG. 7. The metric calculation unit 133 includes a log acquisition unit 151, a profit calculation unit 152, a loss calculation unit 153, and a pipeline evaluation metric calculation unit 154.

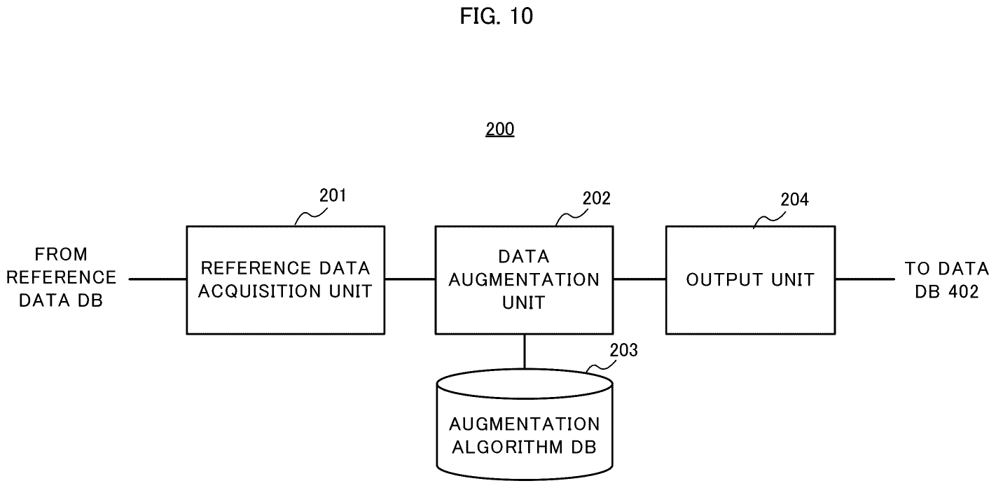

FIG. 10 is a block diagram illustrating a functional configuration of the data generation unit 200 depicted in FIG. 4. The data generation unit 200 includes a reference data acquisition unit 201, a data augmentation unit 202, an augmentation algorithm DB 203, and an output unit 204.

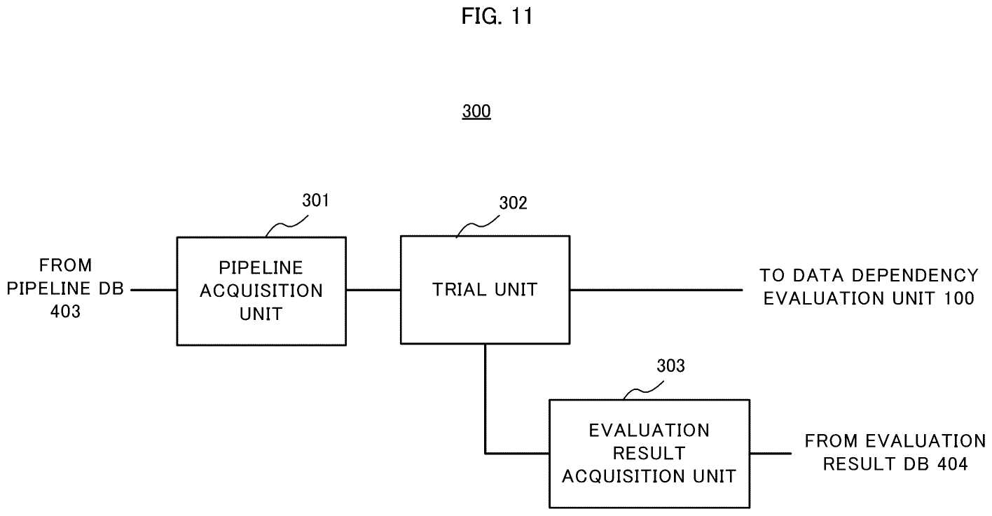

FIG. 11 is a block diagram illustrating a functional configuration of the optimization unit 300 depicted in FIG. 4. The optimization unit 300 includes a pipeline acquisition unit 301, a trial unit 302, and an evaluation result acquisition unit 303.

### [Pipeline Evaluation Unit]

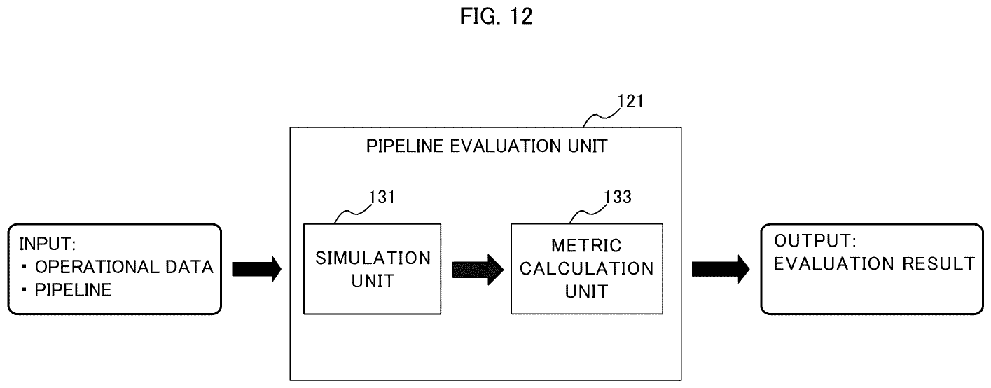

Next, an operation of the pipeline evaluation unit will be described in detail. FIG. 12 schematically illustrates the operation of the pipeline evaluation unit 121. The operational data and the pipeline are input to the pipeline evaluation unit 121. The pipeline evaluation unit 121 executes the pipeline to the input operational data to generate an execution log, and calculates the evaluation metric of the pipeline using the generated execution log to output as the evaluation result.

Specifically, as illustrated in FIG. 7, the simulation unit 131 acquires operational data used for simulation from the data DB 402. In addition, the simulation unit 131 acquires the pipeline to be evaluated from the pipeline DB 403. Then, the simulation unit 131 executes the pipeline using the operational data, generates the execution log, and stores the generated execution log in the log DB 132. The metric calculation unit 133 executes calculates the evaluation metric for evaluating the whole pipeline based on the log stored in the log DB 132, and stores the calculated evaluation metric in the evaluation result DB 122 as the evaluation result.

### (Simulation Unit)

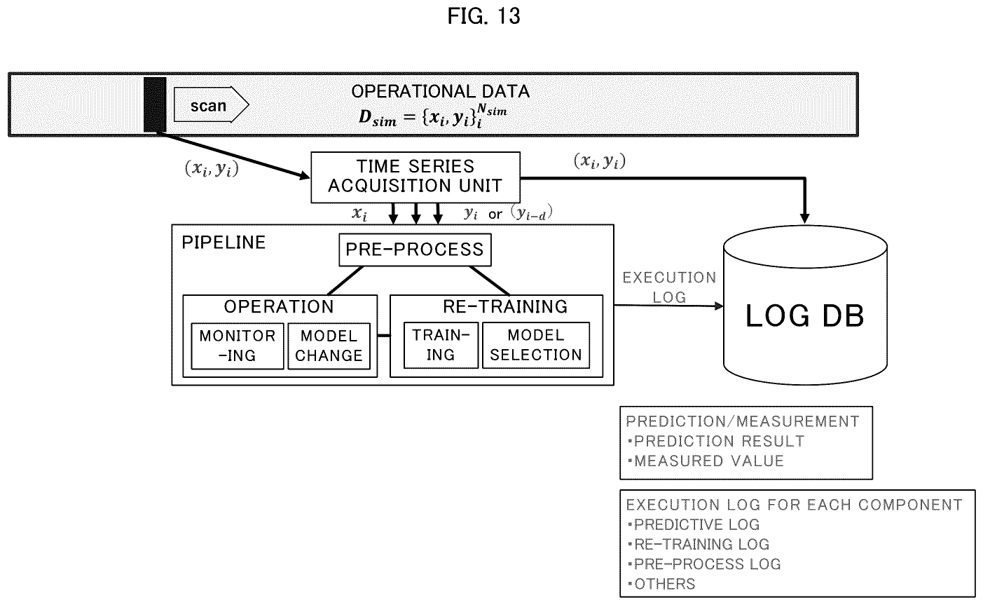

FIG. 13 schematically illustrates an operation of the simulation unit 131. The simulation unit 131 extracts data from the input operational data in chronological order. In detail, the time series acquisition unit 140 retrieves data with a sample size which may be considered to have been processed collectively during the operation. Note that operational data Dₛᵢₘ include an explanatory variable x and an objective variable (label) y. The time series acquisition unit 140 inputs the explanatory variable x and the label y to the pipeline. Note that when the label y is set to be delayed, the time series acquisition unit 140 inputs a label y_{i-d} after the delay into the pipeline. Also, the time series acquisition unit 140 inputs the explanatory variable x and the label (label without delay) y into the log DB 132. The pipeline is executed using the input explanatory variable x, and the execution log being acquired is stored in the log DB 132.

The log DB 132 stores prediction results acquired by the pipeline, and actually measured values. Note that a measured value corresponds to the label y in the operational data. The execution log also includes an execution log for each of the components forming the pipeline. Specifically, as execution logs, as a prediction log by the prediction component included in the pipeline, a retraining log by the retraining component, a pre-process log by the pre-process component, and the like are stored.

Next, with reference to FIG. 8, a specific operation of the simulation unit 131 is described. The time series acquisition unit 140 acquires the operational data from the data DB 402, and inputs the operational data to the pipeline execution unit 142. The pipeline acquisition unit 141 acquires the pipeline to be evaluated from the pipeline DB 403, and inputs the acquired pipeline to the pipeline execution unit 142. The pipeline execution unit 142 sets the acquired pipeline as an execution state. The pipeline in the execution state can accept inputs of operational data, and the operational data are input to the pipeline in the execution state. Depending on the operational data flowing into the time series, the pre-process components, the prediction components, the retraining components, and the like are triggered, and executed individually. Specifically, the pipeline in the execution state executes a process for each of components using information obtained from the model DB 143, the operational data DB 144, and the execution log DB 145. At the same time, the components outputs process results respectively to the model DB 143, the operational data DB 144, and the execution log DB 145.

For instance, the predictive component receives the operational data, and outputs the prediction value using the machine learning model extracted from the model DB 143. The prediction component stores the prediction result in the execution log DB 145, and stores the operational data in the operational data DB 144.

The accuracy monitoring component monitors the accuracy by acquiring the operational data and forecasts from the operational data DB 144 and the execution log DB 145. The accuracy monitoring component stores an accuracy monitoring log in the execution log DB 145. The accuracy monitoring component also triggers the retraining component as needed.

The retraining component retrains a model using the operational data stored in the operational data DB 144, and stores a retraining model in the model DB 143. As described above, the pipeline in an execution state works in coordination with each component via storage areas (the DBs 143 to 145) shared by the components. Instead of providing three DBs 143 to 145 individually, a single DB for the pipeline may be provided.

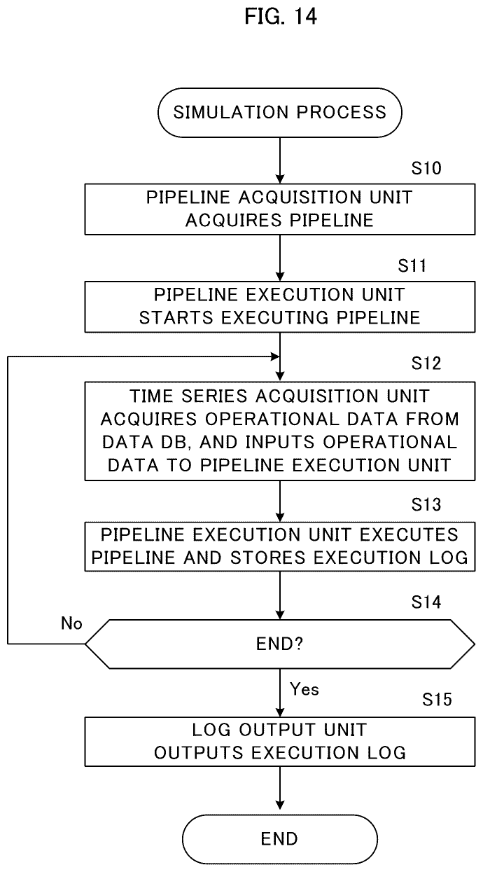

FIG. 14 is a flowchart of the simulation process performed by the simulation unit 131. This process is realized by the processor 12 depicted in FIG. 3 which executes a program prepared in advance and operates as each element depicted in FIG. 8.

First, the pipeline acquisition unit 141 acquires the pipeline from the pipeline DB 403 (step S10), and the pipeline execution unit 142 starts executing the pipeline (step S11). Next, the time series acquisition unit 140 acquires the operational data from the data DB 402, and inputs the operational data to the pipeline execution unit 142 (step S12). The pipeline execution unit 142 executes the pipeline, and stores the execution log in the execution log DB 145 (step S13). When the execution of the pipeline using the operational data has not been completed (step S14: No), this simulation process goes back to step S12. When the execution of the pipeline using the operational data is completed (step S14: Yes), the log output unit 146 extracts the execution log from the execution log DB 145, and outputs the execution log to the log DB 132 (step S15). Accordingly, the simulation process is terminated.

### (Metric Calculation Unit)

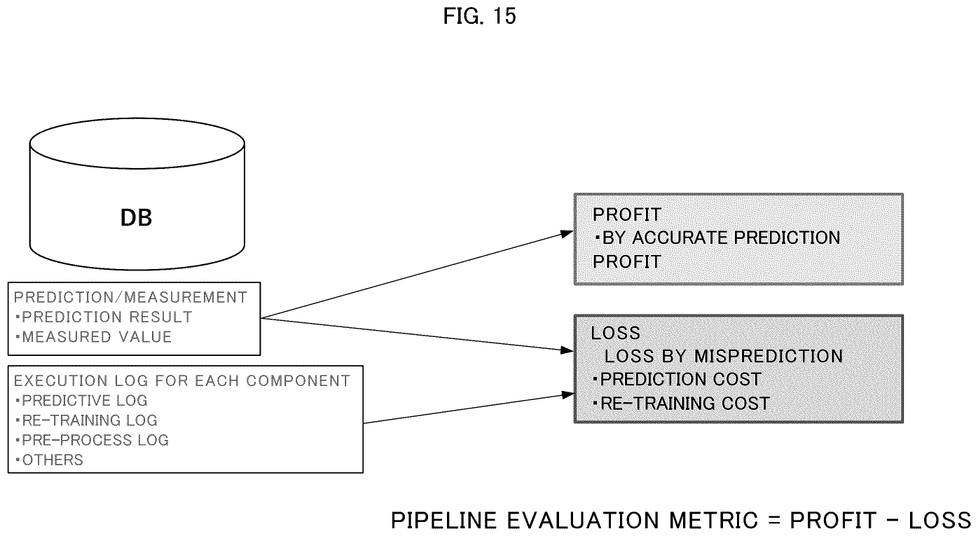

Next, the metric calculation unit 133 will be described. FIG. 15 schematically illustrates an operation of the metric calculation unit 133. The metric calculation unit 133 analyzes the execution log obtained by the execution of the pipeline, and calculates the evaluation metric (hereinafter, referred to as a “pipeline evaluation metric”) to evaluate the entire pipeline. Specifically, the metric calculation unit 133 quantifies a profit and a loss caused by the execution of the pipeline based on information included in the execution log, and sets a difference between the profit and the loss as the pipeline evaluation metric. Note that, a rule for quantifying the profit and the loss may be set in advance or may be defined by a user.

Here, the “profit” corresponds to a profit which the pipeline derives as a result of making a correct prediction. Also, the “loss” may correspond to a loss caused by a mis-prediction of the pipeline, and for instance, may indicate a cost necessary for the prediction for a case in which the prediction result is not valid, a retraining cost to retrain the machine learning model which results in the mis-prediction, and the like. Note that the “cost” can be specifically expressed in terms of a resource, time, and the like needed for the prediction or the retraining. The pipeline evaluation metric is expressed as follows.

(Pipeline evaluation metric)=(Income)−(Loss)

As a simple example, suppose a task of the pipeline is to predict a demand for a product. In a case where the demand prediction is highly accurate and a correct prediction result is obtained, a shop can stock and sell products to meet a predicted increase in demand. Therefore, the metric calculation unit 133 can calculate, as the “profit”, sales of the products corresponding to the predicted increase in demand. On the other hand, in a case where the accuracy of the demand prediction is low and mis-prediction occurs, the metric calculation unit 133 can calculate the various costs caused by the performed prediction as the “loss”. In this example, the pipeline evaluation metric can be considered as a kind of a business benefit.

Next, a specific example of the pipeline evaluation metric will be described. Hereinafter, the profit is expressed by “P” and “p”, and the loss is expressed by “L” and “1”. Now that the pre-process log, the prediction log, the monitoring log, and the retraining log are available as execution logs, the following profit and loss can be calculated based on each log:
(1) Based on the pre-process log, the following losses are obtained.

Execution cost L^{prep}=N^{prep}×l^{prep}
(N^{prep}: pre-process execution count, l^{prep}: calculation cost per pre-process (yen))
(2) Based on the prediction log, the following profit and loss are obtained.

Execution cost L^{pred}=N^{pred}×l^{pred}
(N^{pred}: prediction execution count, l^{pred}: calculation cost per prediction (yen))

Profit by accurate prediction P^{accpred}=N^{accpred}×p^{accpred}
(N^{accpred}: correct answer count of prediction, p^{accpred}: profit from accurate prediction (yen))

Loss by mis-prediction L^{mispred}=N^{mispred}×l^{mispred}
(N^{mispred}: mis-prediction count; l^{mispred}: calculation cost per prediction (yen))
(3) Based on the monitoring log, the following loss is obtained.

Execution cost L^{monitor}=N^{monitor}×l^{monitor}
(N^{monitor}: monitoring execution count, l^{monitor}: calculation cost per monitoring (yen))
(4) Based on the retraining log, the following loss is obtained.

Execution cost L^{retrain}=N^{retrain}×l^{retrain}
(N^{retrain}: retraining execution count, lᵣₑₜᵣₐᵢₙ: calculation cost per retraining (yen))

Therefore, the following total profit can be calculated as the pipeline evaluation metric.

Total profit P^{total}=P^{accpred}−(L^{prep}+L^{pred}+L^{mispred}+L^{monitor}+L^{retrain})

Note that in the above equation, each loss may be weighted and the total profit may be calculated.

Next, with reference to FIG. 9, a specific operation of the metric calculation unit 133 will be described. The log acquisition unit 151 acquires the execution log from the log DB 132 depicted in FIG. 7, and outputs the execution log to the profit calculation unit 152 and the loss calculation unit 153. Each of the profit calculation unit 152 and the loss calculation unit 153 calculates the profit and the loss, for instance as in the example described above, and outputs the profit and the loss to the pipeline evaluation metric calculation unit 154. The pipeline evaluation metric calculation unit 154 calculates a difference between the profit and the loss which have been input, and outputs the difference as the pipeline evaluation metric to the evaluation result DB 122.

### [Random Number Dependency Evaluation Unit]

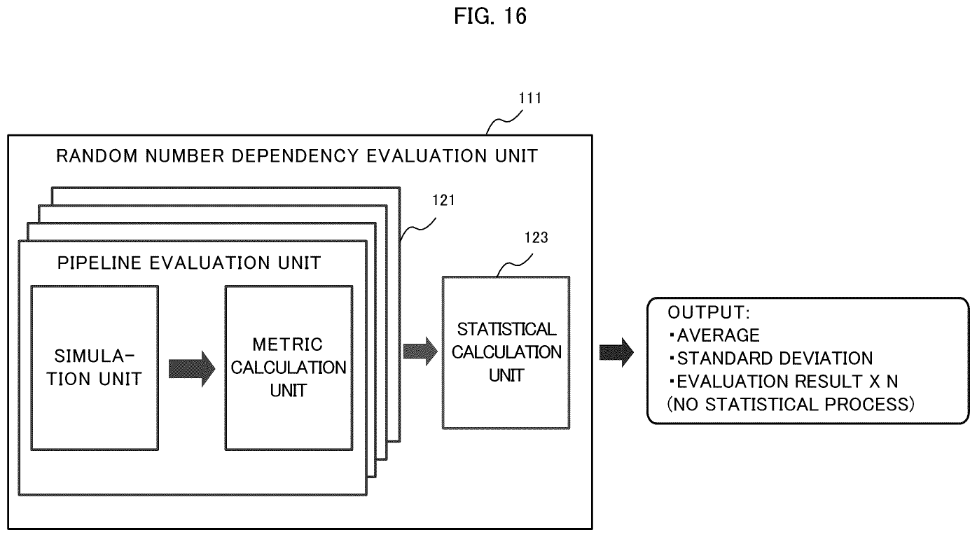

Next, the operation of the random number dependency evaluation unit 111 will be described in detail. FIG. 16 schematically illustrates an operation of the random number dependency evaluation unit 111. The random number dependency evaluation unit 111 evaluates the random number dependency of the pipeline. Specifically, the random number dependency evaluation unit 111 executes the evaluation of the pipeline by the pipeline evaluation unit 121 multiple times (N iterations) while changing the random number seed used in the pipeline. Then, the statistical calculation unit 123 calculates statistics for N evaluation results by the pipeline evaluation unit 121, and evaluates the random number dependency of the pipeline based on the statistics. As the statistics, for instance, the N evaluation results themselves by the pipeline evaluation unit 121, an average thereof, a standard deviation, or the like can be used. For instance, it can be evaluated that the larger a variation or the standard deviation of the N evaluation results, the higher the random number dependency of the pipeline, and the smaller the variation or the standard deviation of the N evaluation results, the lower the random number dependency.

Next, with reference to FIG. 6, a specific operation of the random number dependency evaluation unit 111 will be described. The pipeline evaluation unit 121 executes the pipeline acquired from the pipeline DB 403 using the operational data acquired from the data DB 402. In this case, the pipeline evaluation unit 121 generates a random number by changing the random number seed, and uses the generated random number. The pipeline evaluation unit 121 executes pipeline evaluation N times while changing the random number seed, and stores N evaluation results in the evaluation result DB 122. The statistical calculation unit 123 acquires the N evaluation results from the evaluation result DB 122, calculates the statistics for the N evaluation results, and stores the calculated statistics in the evaluation result DB 112.

Next, in the evaluation of the random number dependency, it will be described how to perform the pipeline evaluation multiple times (N iterations) with changing the random number. Now, assume that the pipeline to be evaluated uses the random number only in the retraining component of the machine learning model. In this case, while changing the random number, the retraining is performed N times while changing the random number. At that time, the random number dependency evaluation unit 111 performs simulation m times using different random number seeds at a timing of executing the retraining component, and divides the simulation to m simulations. This process is repeated, and when the number of branches reaches N, then the division of the simulation is not performed at the retraining, and N simulations are continued.

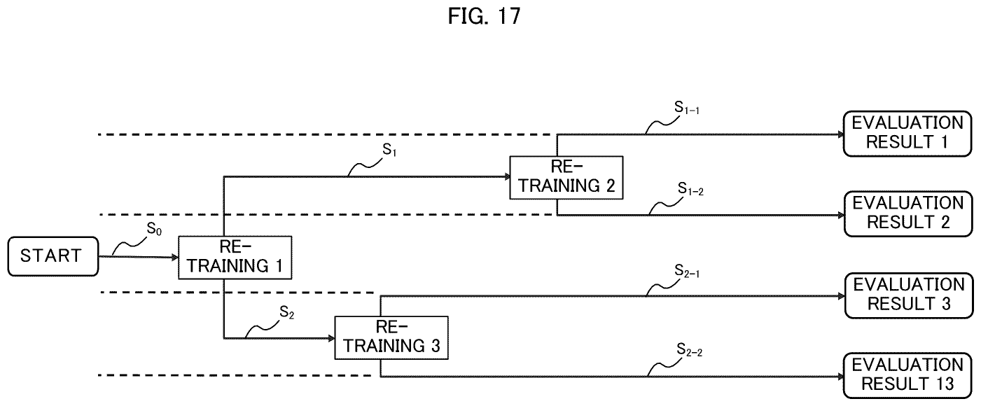

FIG. 17 illustrates an example of a method for performing the pipeline evaluation by changing the random number seed during the retraining. In this example, the random number dependency evaluation during the retraining unit 111 branches the simulation into two portions at the retraining (m=2), and performs a total of four pipeline evaluations (N=4). In FIG. 17, first, when a condition is satisfied for performing the retraining while a simulation S₀ is being executed, retraining 1 is performed. In the retraining 1, the random number dependency evaluation unit 111 starts two simulations S₁ and S₂ using two different random number seeds. When a condition for the retraining is satisfied while the simulation S₁ is being executed, retraining 2 is performed. In the retraining 2, the random number dependency evaluation unit 111 starts two simulations S₁₋₁ and S₁₋₂ using two different random number seeds. In addition, when a condition for the retraining is satisfied while the simulation S₂ is being executed, retraining 3 is performed. In the retraining 3, the random number dependency evaluation unit 111 starts two simulations S₂₋₁ and S₂₋₂ using two different random number seeds. Accordingly, four simulations S₁₋₁, S₁₋₂, S₂₋₁ and S₂₋₂ using different random number seeds are performed. As described above, by branching the simulation each time the retraining occurs and executing the simulation using different random numbers, it is eliminated to perform duplicate simulations for portions of dashed lines depicted in FIG. 17, it is possible to efficiently perform the pipeline evaluation multiple times.

### [Data Generation Unit]

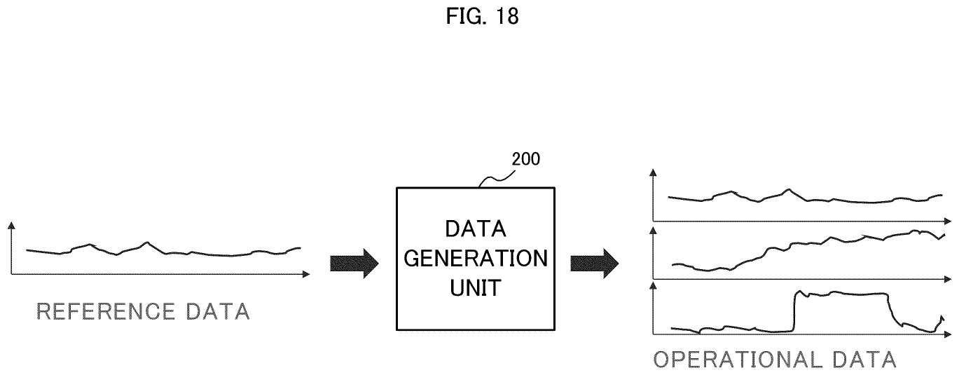

Next, an operation of the data generation unit 200 will be described in detail. The data generation unit 200 generates a plurality of sets of operational data used for the data dependency evaluation. FIG. 18 schematically illustrates the operation of the data generation unit 200. The data generation unit 200 generates a wide variety of operational data based on reference data prepared in advance. Specifically, operational data may be generated as following method.
(1) Reference data are used as is.
(2) The reference data are sorted in a time axis direction.
For instance, the reference data are divided into k blocks while retaining the time series relationship, and k blocks are re-arranged in a time axis direction.
(3) An offset of an objective variable is changed in time series.
For instance, in a case where a task is regression, add a time dependent offset term to the objective variable. In a case where the task is classified, the class label is changed to another class label in a time dependent rate.
(4) The data are augmented using the data augmentation technology.
For instance, an image is reversed or rotated.
(5) The data augmentation technology of time series data is used to augment data.
For instance, a time series GAN (Generative Adversarial Network) is used to generate time series data.
(6) Samples not included in the reference data are added.
For instance, a GAN or an AE (AutoEncoder) is used to generate the samples.

Next, with reference to FIG. 10, a specific operation of the data generation unit 200 will be described. The reference data acquisition unit 201 acquires the reference data from the reference data DB 401, and outputs the reference data to the data augmentation unit 202. The augmentation algorithm DB 203 stores various data augmentation algorithms as described above in advance. The data augmentation unit 202 acquires the data augmentation algorithm to be used from the augmentation algorithm DB 203, performs data augmentation for the reference data, generates the operational data, and outputs the result to the output unit 204. The output unit 204 stores the generated operational data in the data DB 402. Accordingly, various types of operational data are generated based on the reference data prepared in advance.

### [Data Dependency Evaluation Unit]

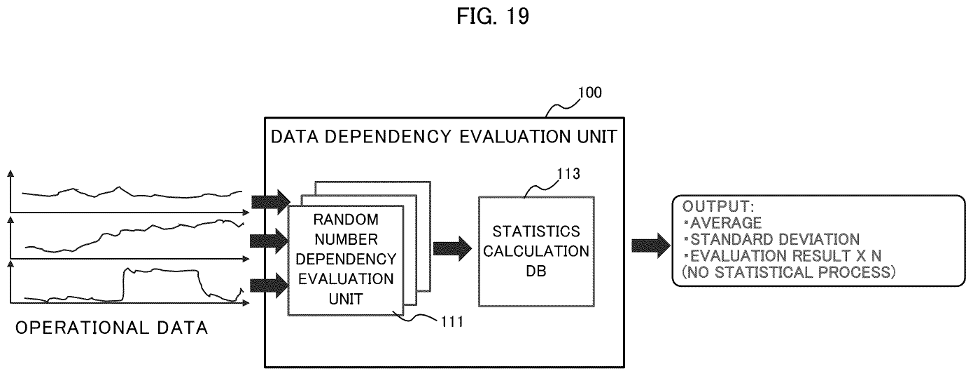

Next, an operation of the data dependency evaluation unit 100 will be described in detail. FIG. 19 schematically illustrates the operation of the data dependency evaluation unit 100. The data dependency evaluation unit 100 evaluates the data dependency of the pipeline. Specifically, the data dependency evaluation unit 100 performs the random number dependency evaluation by the random number dependency evaluation unit 111 for each of a plurality (M sets) of the operational data generated by the data generation unit 200 to obtain M random number dependency evaluation results. In each random number dependency evaluation performed here, the pipeline evaluation is performed by the pipeline evaluation unit 121 multiple times as described above. Accordingly, the statistical calculation unit 113 calculates the statistics for M evaluation results by the random number dependency evaluation unit 111, and evaluates the data dependency of the pipeline based on the statistics. As the statistics, for instance, the M evaluation results themselves by the random number dependency evaluation unit 111, an average thereof, a standard deviation, or the like may be used. For instance, the larger the variation or standard deviation of the M evaluation results, the higher the data dependency of the pipeline, and the smaller the variation or standard deviation of the M evaluation results, the lower the data dependency can be evaluated.

Next, with reference to FIG. 5, a specific operation of the data dependency evaluation unit 100 will be described. The random number dependency evaluation unit 111 executes the pipeline acquired from the pipeline DB 403 with respect to the plurality (M sets) of operational data acquired from the data DB 402. The random number dependency evaluation unit 111 stores the M evaluation results in the evaluation result DB 112. The statistical calculation unit 113 acquires the M evaluation results from the evaluation result DB 112, calculates statistics, and stores the calculated statistics in the evaluation result DB 404.

### [Optimization Unit]

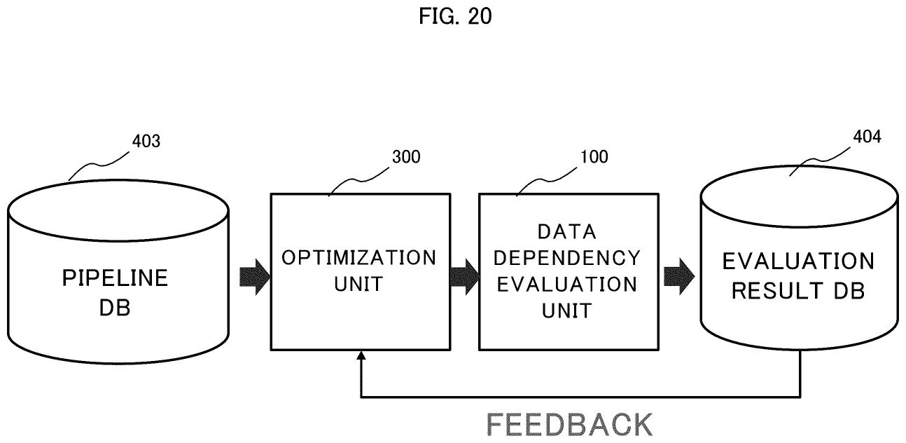

Next, an operation of the optimization unit 300 will be described in detail. FIG. 20 schematically illustrates the operation of the optimization unit 300. The optimization unit 300 optimizes the pipeline based on the evaluation result of the data dependency of the pipeline by the data dependency evaluation unit 100. Specifically, the optimization unit 300 repeats a process for executing different pipelines and acquiring respective evaluation results, and determines the pipeline having the best evaluation result as an optimal pipeline. For instance, the optimization unit 300 repeats a process for executing the pipeline while changing parameters of the pipeline. The parameters to be changed may be, for instance, the pipeline design itself and variable parameters for components in the pipeline. As a specific optimization method, for instance, a grid search (Grid Search) or Bayesian optimization can be used.

Next, with reference to FIG. 11, a specific operation of the optimization unit 300 will be described. The pipeline acquisition unit 301 acquires the pipeline to be evaluated from the pipeline DB 403, and outputs the pipeline to the trial unit 302. The trial unit 302 outputs the acquired pipeline to the data dependency evaluation unit 100 to perform the data dependency evaluation. The evaluation result acquisition unit 303 acquires the evaluation result of the data dependency evaluation unit 100 from the evaluation result DB 404, and inputs the evaluation result to the trial unit 302. The trial unit 302 determines a next pipeline to be evaluated based on the acquired evaluation result, and acquires the pipeline from the pipeline DB 403 through the pipeline acquisition unit 301. Then, the trial unit 302 outputs the next pipeline to be evaluated to the data dependency evaluation unit 100 to perform the data dependency evaluation. Thus, the optimization unit 300 acquires the evaluation results for the plurality of pipelines while changing the pipeline to be evaluated, and selects the pipeline having the best evaluation result.

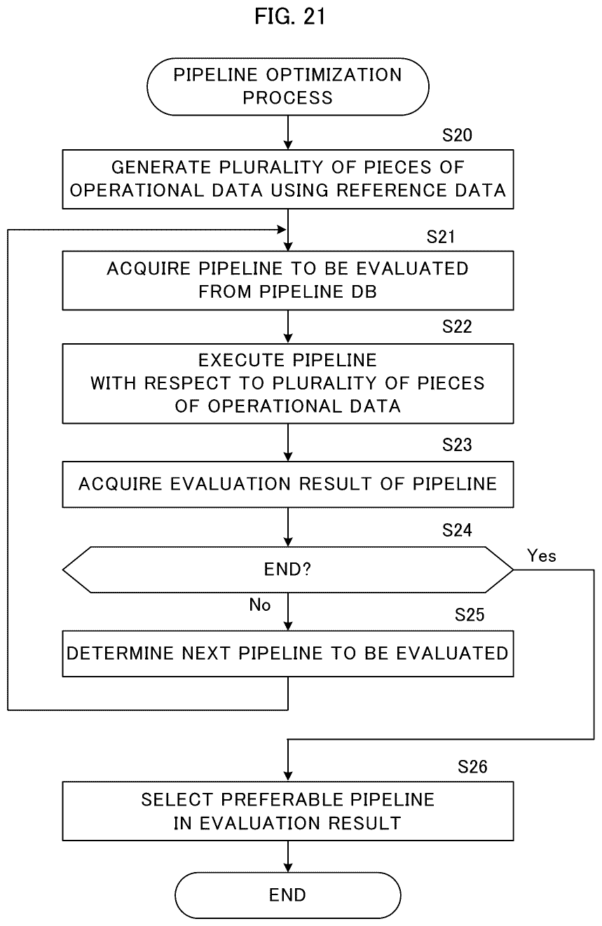

FIG. 21 is a flowchart of a pipeline optimization process performed by the optimization unit 300. This process is realized by executing a program prepared in advance by the processor 12 depicted in FIG. 3. First, the data generation unit 200 generates a plurality of operational data using the reference data (step S20). Next, the optimization unit 300 acquires the pipeline of the trial target from the pipeline DB 403 (step S21). The data dependency evaluation unit 100 executes the pipeline obtained from the optimization unit 300 for the plurality of sets of operational data (step S22). The evaluation results by the data dependency evaluation unit 100 are stored in the evaluation result DB 404, and the optimization unit 300 acquires the evaluation results (step S23).

Next, the optimization unit 300 determines whether or not a predetermined end condition is satisfied (step S24). The end condition may be, for instance, that evaluation results for the plurality of pipelines obtained by predetermined parameter changes are obtained, that the pipeline which of the evaluation result satisfies a predetermined reference is obtained, and the like. When the end condition is not satisfied (step S24: No), the process goes back to step S21 and the next pipeline to be evaluated is executed, and evaluation results for the next pipeline are obtained (step S25). Then, when the termination condition is satisfied (step S24: Yes), the optimization unit 300 selects a pipeline having a preferable evaluation result (step S26). After that, the process is terminated.

### [Specific Examples of Optimization]

### Example 1

Next, an example 1 of the optimization of the pipeline will be described according to the first example embodiment. In this example 1, a pipeline of a demand prediction model of a product is optimized. A task is to regress daily sales of a product A on the day of the week. The pipeline includes a model prediction component, an accuracy monitoring component, and a retraining component, and automatically performs, at a time the accuracy is degraded, the prediction of each model, monitoring of the accuracy of each model, and retraining of each model.

The parameters to be optimized are parameters of the accuracy monitoring component and the retraining component. The optimization unit 300 optimizes a threshold value for the accuracy degradation which triggers the retraining for the accuracy monitoring component, and optimizes an applicable period of the training data at a time of the retraining with respect to the retraining component.

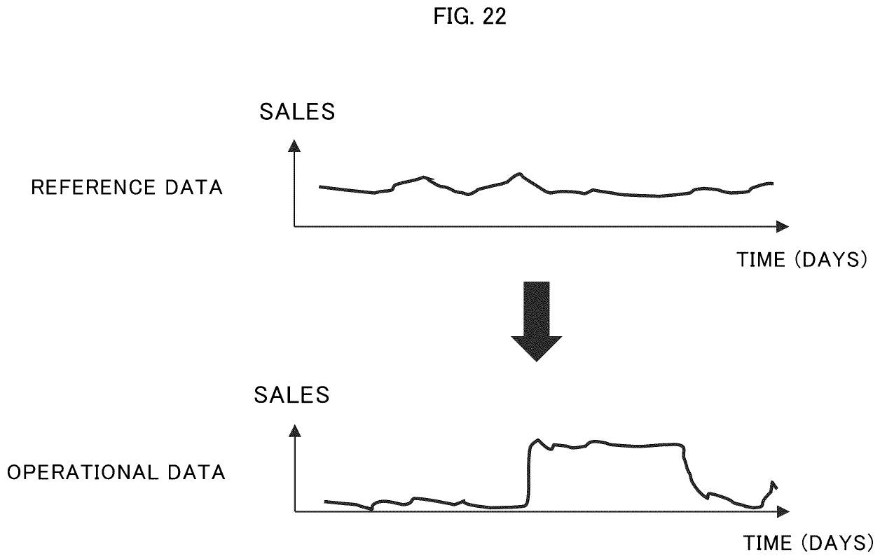

As illustrated in FIG. 22, data to o be adapted are data in which sales suddenly increase from a certain period. The data generation unit 200 generates, based on the reference data, the operational data in which the sales are suddenly increased in a certain period.

As a result from performing the pipeline optimization in the above conditions, a threshold value for the accuracy degradation to trigger the retraining indicates 0.6, and the applicable period of the training data at the time of the retraining indicates one month. Based on this result, it can be inferred that a shorter applicable period of the training data is preferable in order to follow the sudden change of the sales, and that a business loss is not too great even in a case where the threshold value for the accuracy degradation which triggers the retraining is set low.

### Example 2

Moreover, an example 2 of the pipeline optimization will be described according to the first embodiment in a medical/healthcare field. In this example 2, a pipeline of a model for predicting a number of patients visiting a hospital is optimized. The task is to regress a daily number of patients visiting a hospital A from the day of the week. The pipeline includes a model prediction component, an accuracy monitoring component, and a retraining component, and automatically performs, at a time the accuracy is degraded, the prediction of each model, monitoring of the accuracy of each model, and retraining of each model.

The parameters to be optimized are parameters of the accuracy monitoring component and the retraining component. The optimization unit 300 optimizes the threshold value of the accuracy deterioration to trigger for the retraining with respect to the accuracy monitoring component, and also optimizes the applicable period of the training data at the retraining respect to the retraining component.

The data to be adapted are data in which the number of patients visiting the hospital suddenly increases during a certain period as depicted in FIG. 22. The data generation unit 200 generates the operational data in which the number of patients visiting the hospital suddenly increases during the certain period based on the reference data.

As a result from performing the pipeline optimization in the above conditions, the threshold value for the accuracy deterioration to trigger the retraining indicates 0.6, and the target period of training data during retraining indicates one month. Based on this result, it can be inferred that a shorter applicable period of the training data is preferable in order to follow the sudden change of the sales, and that a business loss is not too great even in a case where the threshold value for the accuracy degradation which triggers the retraining is set low.

### [Modification]

### (Modification 1)

In the above-described example embodiment, the pipeline evaluation device 1 includes the pipeline evaluation unit 121, the random number dependency evaluation unit 111, and the data dependency evaluation unit 100, and performs the optimization of the pipeline using the evaluation results by these three evaluation units. However, it is not essential that the pipeline evaluation device 1 includes all of these three evaluation units. For instance, the pipeline evaluation device 1 may include the pipeline evaluation unit 121 and the random number dependency evaluation unit 111. In this case, the optimization unit 300 may optimize the pipeline using the evaluation result by the pipeline evaluation unit 121 and the random number dependency evaluation unit 111. Alternatively, the pipeline evaluation device 1 may include the pipeline evaluation unit 121 and the data dependency evaluation unit 100. In this case, the optimization unit 300 may optimize the pipeline by using the evaluation result by the pipeline evaluation unit 121 and the data dependency evaluation unit 100. Furthermore, the pipeline evaluation device 1 may include only the pipeline evaluation unit 121. In this case, the optimization unit 300 may evaluate the pipeline using the evaluation result of the pipeline evaluation unit 121.

### (Modification 2)

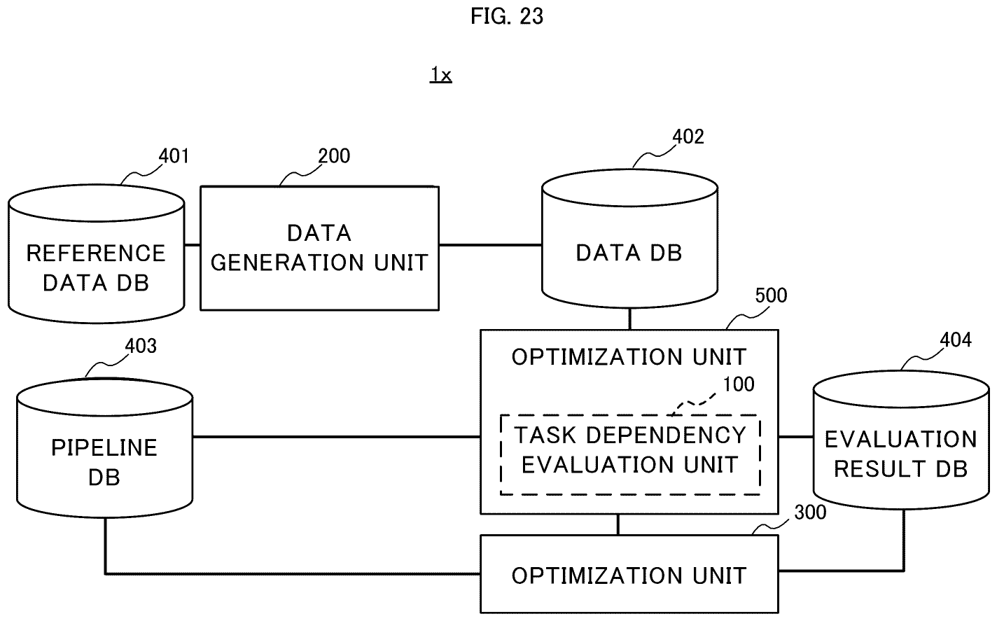

In the above example embodiment may be provided a task dependency evaluation unit including the data dependency evaluation unit therein. FIG. 23 is a block diagram illustrating a schematic configuration of a pipeline evaluation device 1x according to a modification 2. As illustrated in FIG. 23, in the pipeline evaluation device 1x according to the modification 2, the task dependency evaluation unit 500 including the data dependency evaluation unit 100 therein is provided. The task dependency means adaptability of the pipeline to different tasks. Different tasks include not only tasks with different objectives such as the demand prediction and the weather forecast, but also cases where demand predictions for a shop A and a shop B are treated as different tasks even though the demand predictions are the same prediction. In this case, the data generation unit 200 generates the operational data for the different tasks, and the task dependency evaluation unit 500 executes the pipeline using the operational data in the different tasks to generate the evaluation result of the task dependency. Accordingly, the optimization unit 300 may optimize the pipeline based on the evaluation result of the task dependency. Accordingly, it is possible to adapt one pipeline to different tasks.

As in the modification 1, the task dependency evaluation unit 500 may be unnecessary to include internally all of the pipeline evaluation unit 121, the random number dependency evaluation unit 111, and the data dependency evaluation unit 100. For instance, the task dependency evaluation unit 500 may include the pipeline evaluation unit 121 and the random number dependency evaluation unit 111, may include the pipeline evaluation unit 121 and the data dependency evaluation unit 100, or may include the pipeline evaluation unit 121 alone.

### Second Example Embodiment

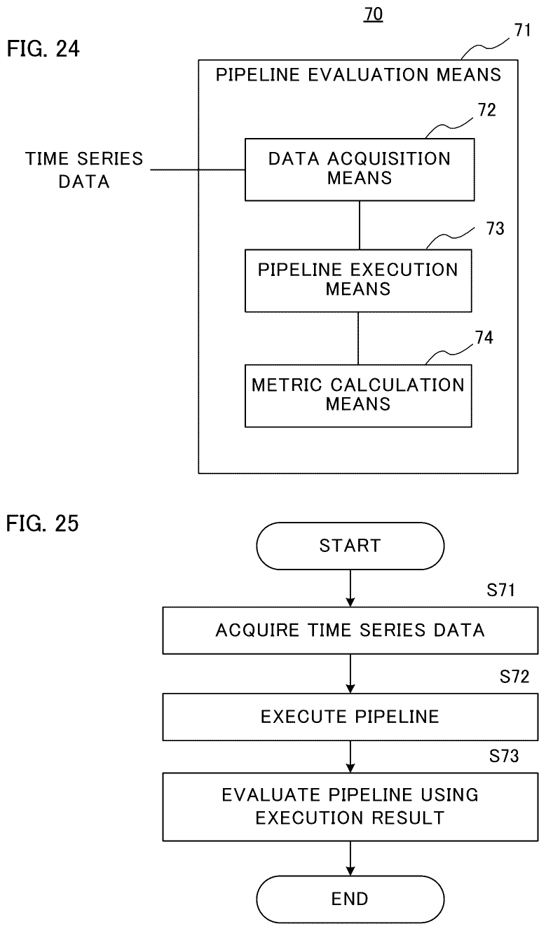

FIG. 24 is a block diagram illustrating a functional configuration of a pipeline evaluation device 70 of the second example embodiment. The pipeline evaluation device 70 includes a pipeline evaluation means 71. The pipeline evaluation means 71 includes a data acquisition means 72, a pipeline execution means 73, and a metric calculation means 74.

FIG. 24 is a flowchart of a process performed by the pipeline evaluation device 70 according to the second example embodiment. The data acquisition means 72 acquires time series data (step S71). The pipeline execution means 73 executes the pipeline using the acquired data, and generates an execution result (step S72). The metric calculation means 74 calculates an evaluation metric to evaluate the pipeline using the execution result based on a profit and a loss obtained by the execution of the pipeline, and outputs the evaluation result (step S73).

According to the pipeline evaluation device 70 of the second example embodiment, it is possible to appropriately evaluate the performance of the entire pipeline.

A part or all of the example embodiments described above may also be described as the following supplementary notes, but not limited thereto.

### (Supplementary Note 1)

A pipeline evaluation device comprising:
at least one memory configured to store instructions; and
at least one processor configured to execute the instructions for a pipeline evaluation process to:
acquire time series data;
execute a pipeline with the acquired time series data, and generate an execution result; and
calculate an evaluation metric using the execution result which evaluates the pipeline based on a profit acquired by executing the pipeline, and output an evaluation result.

### (Supplementary Note 2)

2. The pipeline evaluation device according to supplementary note 1, wherein the evaluation metric is indicated by a difference between the profit and a loss resulting from an execution of the pipeline.

### (Supplementary Note 3)

3. The pipeline evaluation device according to supplementary note 2, wherein
the profit includes a profit in a case of a higher prediction accuracy of a machine learning model included in the pipeline; and
the loss includes a loss in a case of a lower prediction accuracy of the machine learning model.

### (Supplementary Note 4)

4. The pipeline evaluation device according to supplementary note 1, wherein the processor performs a random number dependency evaluation process which evaluates a random number dependency of the pipeline by executing an evaluation in the pipeline evaluation process predetermined times while changing a random seed, generating the evaluation result, and calculating statistics with respect to the evaluation result.

### (Supplementary Note 5)

5. The pipeline evaluation device according to supplementary note 4, wherein the processor performs a data dependency evaluation process which evaluates a data dependency of the pipeline by executing the evaluation the pipeline evaluation process or the random number dependency evaluation process predetermined times while changing operational data, generating the evaluation result, and calculating the statistics with respect to the evaluation result.

### (Supplementary Note 6)

6. The pipeline evaluation device according to supplementary note 5, wherein in the data dependency evaluation process, the processor performs a data generation process which generates a plurality of sets of operational data based on reference data.

### (Supplementary Note 7)

7. The pipeline evaluation device according to supplementary note 5, wherein the processor performs a pipeline optimization process which executes the evaluation in at least one of the pipeline evaluation process, the random number dependency evaluation process, and the data dependency evaluation process while changing parameters of the pipeline, and determines optimal parameters based on the evaluation result being acquired.

### (Supplementary Note 8)

8. The pipeline evaluation device according to supplementary note 7, wherein the processor performs a task dependency evaluation process which evaluates, by using a plurality of sets of data corresponding to different tasks, a task dependency of the pipeline by executing the evaluation by at least one of the pipeline evaluation process, the random number dependency evaluation process, and the data dependency evaluation process, and calculating the statistics with respect to the evaluation result being acquired.

### (Supplementary Note 9)

9. A pipeline evaluation method executed by a computer for a pipeline evaluation process, the method comprising:
acquiring time series data;
executing a pipeline with the acquired time series data, and generating an execution result; and
calculating an evaluation metric using the execution result which evaluates the pipeline based on a profit acquired by executing the pipeline, and outputting an evaluation result.

### (Supplementary Note 10)

10. A non-transitory computer readable recording medium storing a program, the program causing a computer to perform a pipeline evaluation process comprising:
acquiring time series data;
executing a pipeline with the acquired time series data, and generating an execution result; and
calculating an evaluation metric using the execution result which evaluates the pipeline based on a profit acquired by executing the pipeline, and outputting an evaluation result.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

100 Data dependency evaluation unit
111 Random number dependency evaluation unit
121 Pipeline evaluation unit
131 Simulation unit
133 Metric calculation unit
140 Time series acquisition unit
141 Pipeline acquisition unit
142 Pipeline execution unit
152 Profit calculation unit
153 Loss calculation unit
154 Pipeline evaluation metric calculation unit
200 Data generation unit
300 Optimization unit

1. A pipeline evaluation device comprising:
at least one memory configured to store instructions; and
at least one processor configured to execute the instructions for a pipeline evaluation process to:
acquire time series data;
execute a pipeline with the acquired time series data, and generate an execution result; and
calculate an evaluation metric using the execution result which evaluates the pipeline based on a profit acquired by executing the pipeline, and output an evaluation result.

2. The pipeline evaluation device according to claim 1, wherein the evaluation metric is indicated by a difference between the profit and a loss resulting from an execution of the pipeline.

3. The pipeline evaluation device according to claim 1, wherein
the profit includes a profit in a case of a higher prediction accuracy of a machine learning model included in the pipeline; and
the loss includes a loss in a case of a lower prediction accuracy of the machine learning model.

4. The pipeline evaluation device according to claim 1, wherein the processor performs a random number dependency evaluation process which evaluates a random number dependency of the pipeline by executing an evaluation in the pipeline evaluation process predetermined times while changing a random seed, generating the evaluation result, and calculating statistics with respect to the evaluation result.

5. The pipeline evaluation device according to claim 4, wherein the processor performs a data dependency evaluation process which evaluates a data dependency of the pipeline by executing the evaluation the pipeline evaluation process or the random number dependency evaluation process predetermined times while changing operational data, generating the evaluation result, and calculating the statistics with respect to the evaluation result.

6. The pipeline evaluation device according to claim 5, wherein in the data dependency evaluation process, the processor performs a data generation process which generates a plurality of sets of operational data based on reference data.

7. The pipeline evaluation device according to claim 5, wherein the processor performs a pipeline optimization process which executes the evaluation in at least one of the pipeline evaluation process, the random number dependency evaluation process, and the data dependency evaluation process while changing parameters of the pipeline, and determines optimal parameters based on the evaluation result being acquired.

8. The pipeline evaluation device according to claim 7, wherein the processor performs a task dependency evaluation process which evaluates, by using a plurality of sets of data corresponding to different tasks, a task dependency of the pipeline by executing the evaluation by at least one of the pipeline evaluation process, the random number dependency evaluation process, and the data dependency evaluation process, and calculating the statistics with respect to the evaluation result being acquired.

9. A pipeline evaluation method executed by a computer for a pipeline evaluation process, the method comprising:
acquiring time series data;
executing a pipeline with the acquired time series data, and generating an execution result; and
calculating an evaluation metric using the execution result which evaluates the pipeline based on a profit acquired by executing the pipeline, and outputting an evaluation result.

10. A non-transitory computer readable recording medium storing a program, the program causing a computer to perform a pipeline evaluation process comprising:
acquiring time series data;
executing a pipeline with the acquired time series data, and generating an execution result; and
calculating an evaluation metric using the execution result which evaluates the pipeline based on a profit acquired by executing the pipeline, and outputting an evaluation result.
